(19) United States
(12) Patent Application Publication
(10) Pub. No.: US 2021/0239356 A1
(43) Pub. Date: Aug. 5, 2021

(54) Air-conditioning drain line sanitation device and system

(71) Applicant: Todd E. Thompson, Bradenton, FL (US)

(72) Inventor: Todd E. Thompson, Bradenton, FL (US)

(21) Appl. No.: 17/236,805

(22) Filed: Apr. 21, 2021

Related U.S. Application Data
(63) Continuation-in-part of application No. 16/059,545, filed on Aug. 9, 2018, now abandoned.

(51) Int. Cl. F24F 13/22

(52) U.S. Cl. CPC F24F 13/222; F24F 2013/228

(57) ABSTRACT

An air-conditioning drain line sanitation system includes: an air-conditioning unit with a drain emission connector; a drain line; and an air-conditioning drain line sanitation device, including a line fitting with a connector pipe segment and a container connector, and a container assembly, including a sealing plate with at least one sealing aperture, a sealing ring, and a container body with a sanitation composition, such that the air-conditioning drain line sanitation device mixes condensate fluid emitted from the drain emission connector with the sanitation composition, such that the sanitation composition sanitizes the condensate fluid and the drain line, whereby a risk of clogging the drain line is reduced.

### CROSS-REFERENCE TO RELATED APPLICATIONS

This U.S. Non-Provisional application is a Continuation-In-Part of U.S. Non-Provisional application Ser. No. 16/059,545, filed Aug. 9, 2018; which is hereby included herein by reference in its entirety.

### FIELD OF THE INVENTION

The present invention relates generally to the field of air-conditioning systems, and more particularly to methods and systems for maintaining air-conditioning drain lines in a sanitized state.

### BACKGROUND OF THE INVENTION

Air-conditioning systems are ubiquitous in the United States for both residential and commercial use.

However, in continued use air-conditioning drain lines may develop internal growth bacteria, algae, and/or fungus, which can cause the drain to become clogged and thereby cause damage to housing parts and structures, and also cause emission of unpleasant odors.

As such, considering the foregoing, it may be appreciated that there continues to be a need for novel and improved devices and methods for maintaining air-conditioning drain lines in a sanitized state.

### SUMMARY OF THE INVENTION

The foregoing needs are met, to a great extent, by the present invention, wherein in aspects of this invention, enhancements are provided to the existing model of air-conditioning drain line maintenance and sanitation.

In an aspect, an air-conditioning drain line sanitation system can:
a) an air-conditioning unit, including a drain emission connector that emits a condensate fluid from the air-conditioning unit during operation;
b) a drain line with a hollow interior to allow the condensate fluid to flow away from the air-conditioning; and
c) an air-conditioning drain line sanitation device, which includes a container with a sanitation composition, wherein the container is removably attached to the air-conditioning drain line sanitation device;
wherein the air-conditioning drain line sanitation device can be connected between an outer end of the drain emission connector and a first end of the drain line to create a fluid connection between the drain emission connector and the drain line; wherein the air-conditioning drain line sanitation device is configured to mix the condensate fluid emitted from the drain emission connector with the sanitation composition, such that the sanitation composition sanitizes the condensate fluid and the drain line, whereby a risk of clogging the drain line is reduced.

In a related aspect, the air-conditioning drain line sanitation device can further include a line fitting, including:
a) a connector pipe segment, comprising inner and outer ends, and a connector aperture in a bottom side of the connector pipe segment; and
b) a container connector, which can be connected to the bottom side of the connector pipe segment, around the connector aperture;
wherein the container can be removably attached to the container connector, such that an interior of the container is in fluid contact with the connector pipe segment via the connector aperture.

In another related aspect, the container can further include:
a) a container, such that an upper end of the container is configured to detachably connect to a lower end of the container connector to create a tight lock; and optionally
such that the condensate fluid flows via the upper opening of the container into the interior, such that the condensate fluid mixes with the sanitation composition;
whereby a flow of condensate fluid past the connector aperture in the connector pipe segment causes the condensate fluid mixed with the sanitation composition to flow back into the connector pipe segment and subsequently into the drain line.

In a further related aspect, the container can further include:
a sealing plate, which is locked in place on top of the container, such that the sealing plate comprises sealing apertures, to allow the condensate fluid to flow via the sealing apertures and the upper opening of the container into the interior.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. In addition, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a schematic diagram illustrating an air-conditioning drain line sanitation system, according to an embodiment of the invention.

FIG. 2 is a perspective view of an air-conditioning drain line sanitation device, according to an embodiment of the invention.

FIG. 3A is a top perspective view of an air-conditioning drain line sanitation device in an opened state, according to an embodiment of the invention.

FIG. 3B is a bottom perspective view of an air-conditioning drain line sanitation device in an opened state, according to an embodiment of the invention.

FIG. 3C is a perspective view of a container assembly of an air-conditioning drain line sanitation device, according to an embodiment of the invention.

FIG. 4 is a side view of an air-conditioning drain line sanitation device in an opened state, according to an embodiment of the invention.

FIG. 5 is a front view of an air-conditioning drain line sanitation device in an opened state, according to an embodiment of the invention.

FIG. 6A is a front view of an air-conditioning drain line sanitation device, according to an embodiment of the invention.

FIG. 6B is a cross-sectional front view of an air-conditioning drain line sanitation device, according to an embodiment of the invention.

### DETAILED DESCRIPTION

Before describing the invention in detail, it should be observed that the present invention resides primarily in a novel and non-obvious combination of elements and process steps. So as not to obscure the disclosure with details that will readily be apparent to those skilled in the art, certain conventional elements and steps have been presented with lesser detail, while the drawings and specification describe in greater detail other elements and steps pertinent to understanding the invention.

The following embodiments are not intended to define limits as to the structure or method of the invention, but only to provide exemplary constructions. The embodiments are permissive rather than mandatory and illustrative rather than exhaustive.

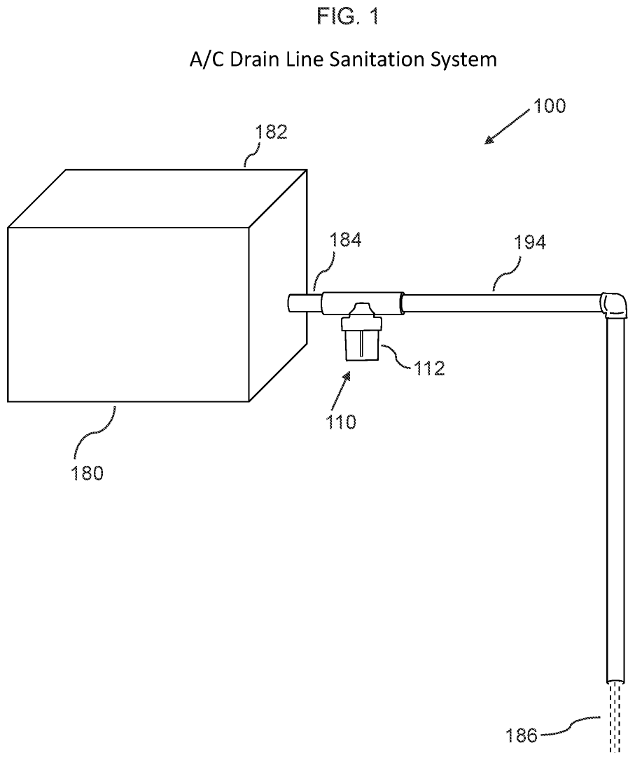

In the following, we describe the structure of an embodiment of an air-conditioning drain line sanitation system 100 with reference to FIG. 1, in such manner that like reference numerals refer to like components throughout; a convention that we shall employ for the remainder of this specification.

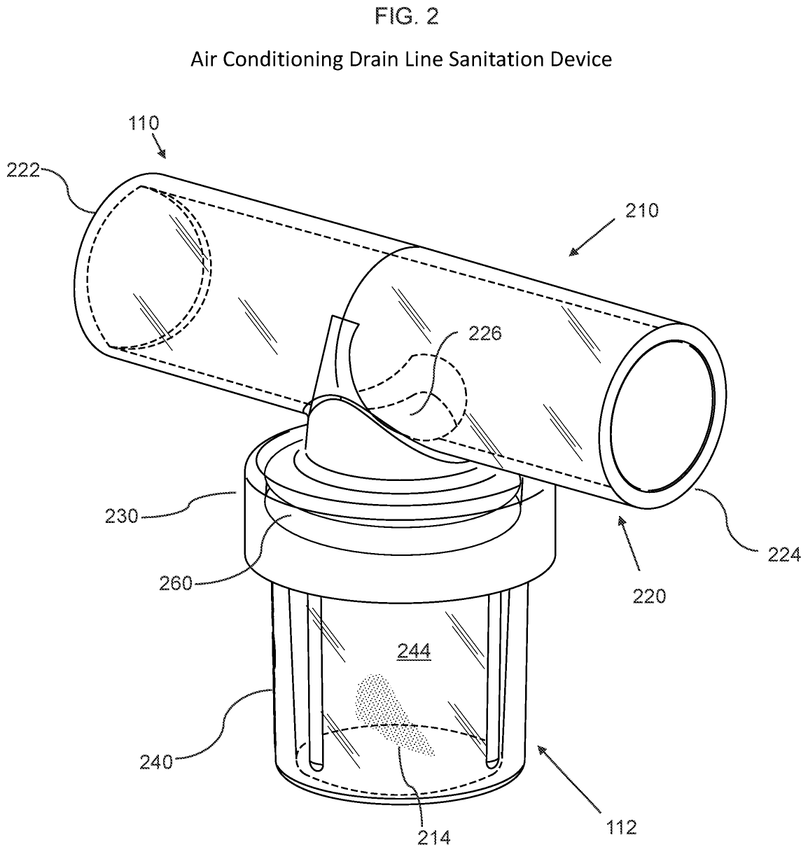

In an embodiment, as shown in FIG. 1, an air-conditioning drain line sanitation system 100 can include:
a) an air-conditioning unit 180, comprising an air-conditioning enclosure 182 and a drain emission connector 184 positioned on a side of the air-conditioning enclosure 182, such that the drain emission connector 184 is configured to emit a condensate fluid 186 from the air-conditioning unit 180 during operation of the air-conditioning unit 180;
b) A drain line 194 which is configured with a hollow interior to allow the condensate fluid 186 to flow away from the air-conditioning unit 180 via the drain line 194; and
c) an air-conditioning drain line sanitation device 110, which comprises a container assembly 112, which comprises a container body 240, which comprises a sanitation composition 214, as shown in FIG. 2, wherein the container body 240 can be configured to be detachable from a container connector 230 of a line fitting 210 of the air-conditioning drain line sanitation device 110;
wherein the air-conditioning drain line sanitation device 110 is connected between an outer end of the drain emission connector 184 and a first end of the drain line 194 to create a fluid connection between the drain emission connector 184 and the drain line 194; wherein the air-conditioning drain line sanitation device 110 is configured to mix the condensate fluid 186 emitted from the drain emission connector 184 with the sanitation composition 214 such that the sanitation composition 214 sanitizes the condensate fluid 186 and the drain line 194, whereby a risk of clogging of the drain line 194 is reduced. The condensate fluid 186 can generally be water but contain debris and contaminants. Installation of the air-conditioning drain line sanitation device 110 will in general not impede the current flow rate or performance of the drain line 194.

In related embodiments, use of the air-conditioning drain line sanitation device 110 is not restricted to use on air-conditioning units 180 and systems, but can be installed for any drain line in HVAC systems or other systems from which fluids are emitted, or can be used for any pipe installation with fluid flow, such as industrial pipe systems, for example in the food or chemical industries. The line sanitation device 110 can be used with gravity fed, low flow, or non-pressurized flow pipe lines.

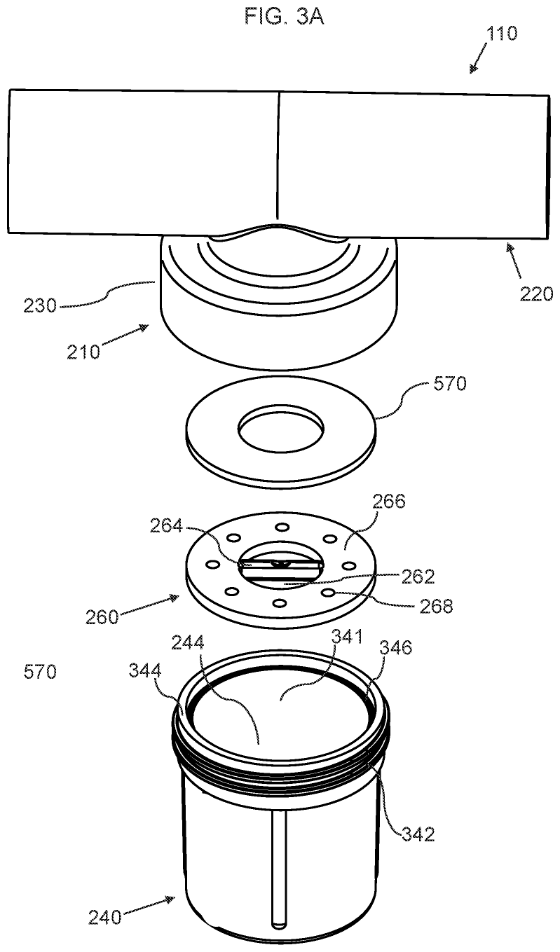

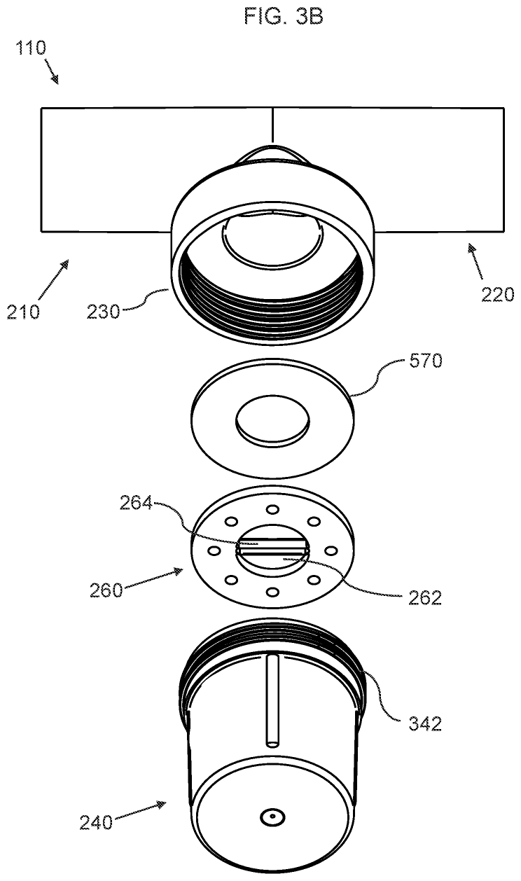

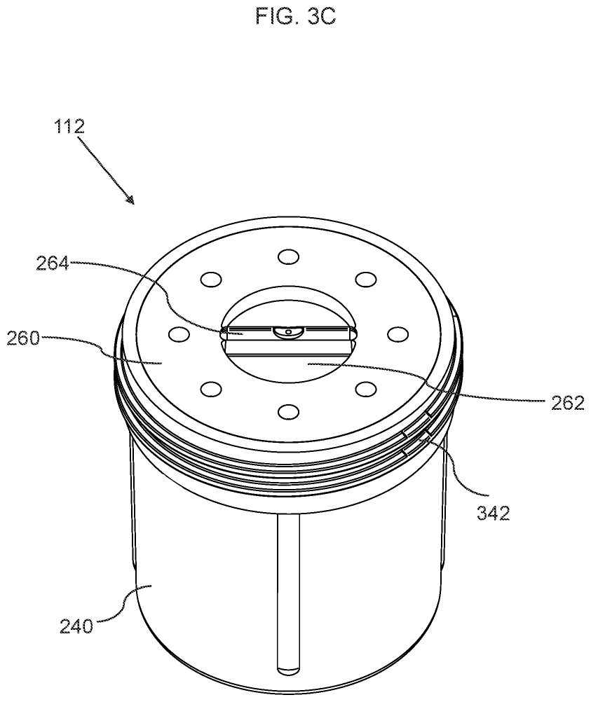

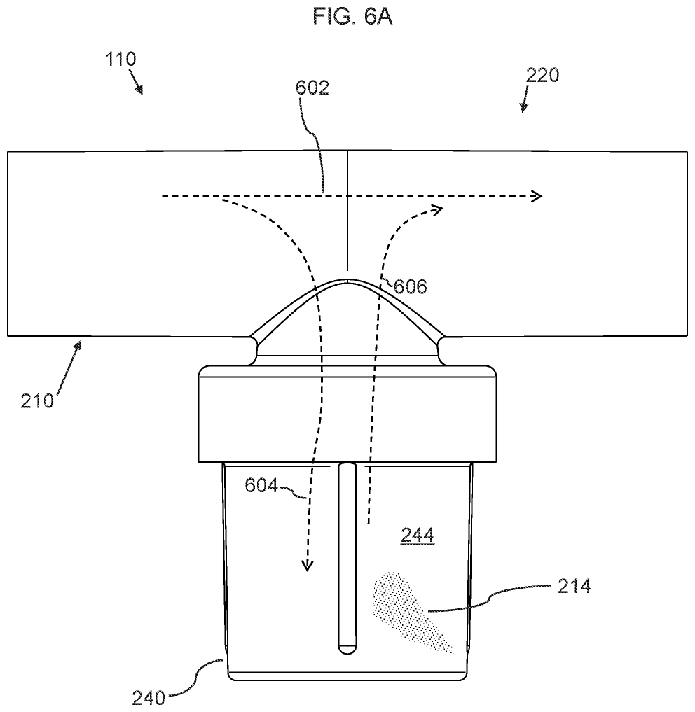

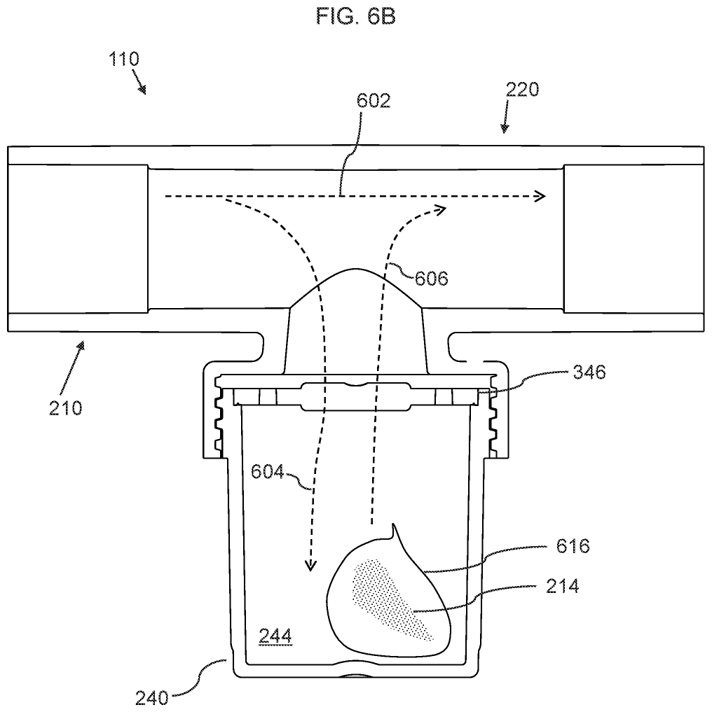

In a related embodiment, as shown in FIG. 2, an air-conditioning drain line sanitation device 110 can include:
a) a line fitting 210, which is configured as a tee pipe fitting, such that the line fitting 210 can include:
   i. a connector pipe segment 220, including inner and outer ends 222 224, and a connector aperture 226 in a bottom side of the connector pipe segment 220; and
   ii. a container connector 230, which is connected to the bottom side of the connector pipe segment, around the connector aperture 226
b) a container assembly 112, which is configured to be removably attachable to the container connector 230, for example via a snap lock and/or screw on fitting, such that an interior of the container is in fluid contact with the connector pipe segment 220 via the connector aperture 226, wherein the interior of the container assembly 112 is configured to contain a sanitation composition 214;
such that an upper end of the container body 240 can be configured with a line connector 342, which is configured to detachably connect to a lower end of the container connector 230 to create a tight lock, for example such that the upper end of the container body 240 can be configured with a line connector 342, such as a snap-lock connector 342 with snap lock tabs 342, or a threaded connector 342 which includes screw-in threading 342, as shown in FIGS. 3A and 3B, that can lock or screw into (or onto) the lower end of the container connector 230. The connection of the container is airtight and integrates into existing pressurized operation of the condensate drain line 194;
c) a sanitation composition 214, which can be positioned in an interior 244 of the container body 240. As shown in FIG. 2, the sanitation composition 214 can be configured as one tablet 214, which for example can be a cylindrical tablet 214, such that the tablet 214 is configured to fit inside the container body 240; and
d) a sealing plate 260, which is positioned in place on top of the container body 240, between the lower end of the container connector 230 and the container body 240, such that the sealing plate 260 can include at least one sealing aperture 262, to allow the condensate fluid 186 to flow via the at least one sealing aperture 262 into 604 the interior 244, as shown in FIG. 6A, such that the condensate fluid 186 mixes with the sanitation composition 214;
wherein the sealing plate 260 is permanently connected to the container body 240, such that the sealing plate 260 can for example be sonic welded, glued, hot welded to the container body 240;
whereby, as shown in FIG. 6A, the flow 602 of condensate fluid 186 past the connector aperture 226 will create a drag which causes the condensate fluid 186 mixed with the sanitation composition 214 to flow back 606 into the drain line 190.

In a related embodiment, as shown in FIG. 2, an air-conditioning drain line sanitation device 110 can include:
a) a line fitting 210, which can be configured as a tee pipe fitting, such that the line fitting 210 can include:
   i. a connector pipe segment 220, including inner and outer ends 222 224, and a connector aperture 226 in a bottom side of the connector pipe segment 220; and
   ii. a container connector 230, which is connected to the bottom side of the connector pipe segment, around the connector aperture 226
b) a container assembly 112, which is configured to be removably attachable to the container connector 230, for example via a snap lock and/or screw on fitting, such that an interior of the container is in fluid contact with the connector pipe segment 220 via the connector aperture 226, wherein the interior of the container assembly 112 is configured to contain a sanitation composition 214, such that the container assembly 112 can include:
   i. a container body 240, such that an upper end of the container body 240 is configured to detachably connect to a lower end of the container connector 230 to create a tight lock, for example such that the upper end of the container body 240 is configured with a line connector 342, such as a snap-lock connector 342 with snap lock tabs 342, or a screw-in threading 342, as shown in FIGS. 3A and 3B, that can lock or screw into (or onto) the lower end of the container connector 230. The connection of the container is air tight and integrates into existing pressurized operation of the condensate drain line 194;
   ii. a sanitation composition 214, which can be positioned in the interior 244 of the container body 240; and
   iii. a sealing plate 260, which is locked in place on top of the container body 240, such that the sealing plate 260 can include at least one sealing aperture 262, which can be sealing apertures 262, to allow the condensate fluid 186 to flow via the apertures into 604 the interior 244, as shown in FIG. 6B, such that the condensate fluid 186 mixes with the sanitation composition 214;
whereby, as shown in FIG. 6B, the flow 602 of condensate fluid 186 past the connector aperture 226 will create a drag which causes the condensate fluid 186 mixed with the sanitation composition 214 to flow back 606 into the drain line 194.

In a related embodiment, as shown in FIG. 3A, the container body 240 can further include:
a) an upper opening 341; and
b) the interior 244 that is accessible via the upper opening 341;
such that an upper end of the container body 240 is configured to detachably connect to a lower end of the container connector 230 to create a tight lock;
such that the condensate fluid 186 flows via the upper opening 341 into the interior 244, such that the condensate fluid 186 mixes with the sanitation composition 214;
whereby a flow of condensate fluid 186 past the connector aperture 226 in the connector pipe segment 220 causes the condensate fluid 186 mixed with the sanitation composition 214 to flow back into the connector pipe segment 220 and subsequently into the drain line 194.

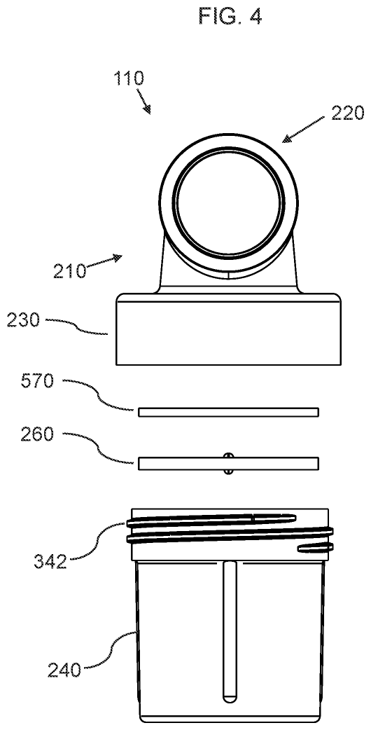

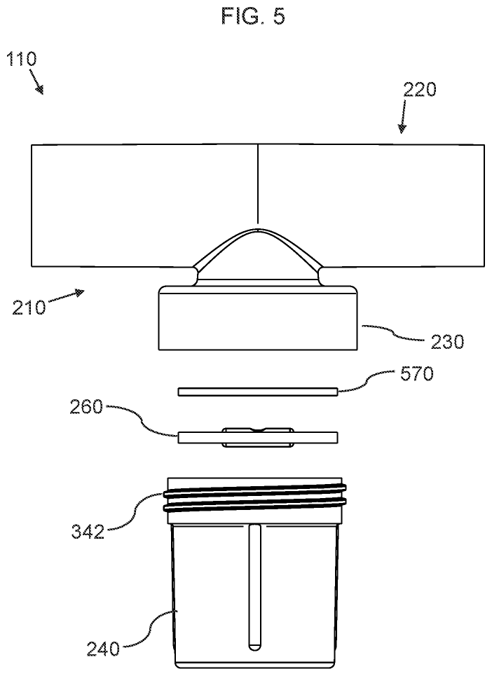

In a related embodiment, as shown in FIGS. 4 and 5, the container assembly 112 can further include a sealing ring 570, which is mounted between the container body 240 and the container connector 230, such that an upper end of the container body 240 is configured to detachably connect to a lower end of the container connector 230 to create a tight lock.

In another related embodiment, as shown in FIGS. 3A and 6B, the container assembly 112 can be configured with an inside ledge 346 on an inner side of an upper rim 344 of the container body 240, such that the sealing plate 260 rests on the inside ledge 346, such that an upper surface of the sealing plate 260 is flush with an upper surface of the upper rim 344 of the container, as shown in FIG. 5.

In yet a related embodiment, the air-conditioning drain line sanitation device 110 can further include:
a) a sealing ring 570, which is positioned between the sealing plate 260 and the container connector 230.

In another related embodiment, the at least one sealing aperture 262 of the sealing plate 260 can include:
a) a central aperture 262 configured with a cross-diagonal bar 264, which partitions the central aperture 262;
wherein the air-conditioning drain line sanitation device 110 can further include:
   a dissolvable bag 616, which is positioned in the interior 244 of the container body 240, wherein the dissolvable bag 616 can be configured to be dissolvable by the condensate fluid 186, wherein the dissolvable bag 616 comprises the sanitation composition 214;
such that the cross-diagonal bar 264 prevents removal of the dissolvable bag 616 with the sanitation composition 214 from the container body 240, and
such that the cross-diagonal bar 264 prevents the dissolvable bag 616 with the sanitation composition 214 from floating upwards, from the container body 240 into the container connector 230, and blocking the connector aperture 226 and/or the container connector 230 during use of the air-conditioning drain line sanitation device 110.

In a further related embodiment, the dissolvable bag 616 can be made from water dissolvable paper, polymer, or another water dissolvable material.

In another related embodiment, the sealing plate 260 can further include:
a) a disc-shaped peripheral member 266, which can include:
   a central aperture 262, wherein the at least one sealing aperture 262 comprises the central aperture 262;
wherein the sealing ring 570 is disc-shaped, such that the sealing ring 570 is positioned on a top of the disc-shaped peripheral member 266.

In a further related embodiment, the disc-shaped peripheral member 266 can be further configured with:
a) a plurality of sealing apertures 268, such that the sealing apertures aid in detachment of the container from the container connector 230, by reducing a suction effect between the sealing ring 570 and the disc-shaped peripheral member 266. The sealing apertures 268 can be equidistantly distributed around the disc-shaped peripheral member 266.

In a related embodiment, the sealing apertures 262 can each have a diameter in a range of for example of 0.1 to 10 mm or 0.5 to 10 mm.

In a related embodiment, as shown in FIG. 2, the line fitting 210, the container body 240 can be made of a transparent material such that the air-conditioning drain line sanitation device 110 provides visibility to the flow of condensate fluid 186. The transparent material can be a transparent plastic material, such as for example polymethylmethacrylate, cellulose acetate butyrate, polycarbonate, or glycol modified polyethylene terephthalate.

In related embodiments, the sanitation composition 214 can be:
a) a powder composition 214, which can be water soluble, such that the powder composition 214 dissolves in the condensate fluid 186, such that the powder composition 214 can be configured to comprise cleaning and/or antimicrobial/disinfectant agents/materials;
b) a granulate composition 214, which can be water soluble, such that the granulate composition 214 dissolves in the condensate fluid 186, such that the granulate composition 214 can be configured to comprise cleaning and/or antimicrobial/disinfectant agents/materials;
c) blocks/pellets/tablets 214 of a compressed powder/granulate composition 214, which can be water soluble, such that the blocks/pellets/tablets 214 dissolve in the condensate fluid 186, such that the blocks/pellets 214 can be configured to comprise cleaning and/or antimicrobial/disinfectant agents/materials;
d) a liquid composition 214, which can be water soluble, such that the liquid composition 214 dissolves in the condensate fluid 186, such that the liquid composition 214 can be configured to comprise cleaning and/or antimicrobial/disinfectant agents/materials; or
e) a gel composition 214, which can be water soluble, such that the gel composition 214 dissolves in the condensate fluid 186, such that the gel composition 214 can be configured to comprise cleaning and/or antimicrobial/disinfectant agents/materials. In related embodiment, a powder composition 214 can be configured to transform into a gel composition 214.

In a further related embodiment, the sanitation composition 214 can be a liquid composition 214 including a quaternary ammonium chloride solution.

In another further related embodiment, the sanitation composition 214 can be a powder, granulate or block/pellet composition 214 including chlorine, bromine, Biguanide, or a combination of these.

In various related embodiments, the drain line sanitation system 100 can for example alternatively be called a drain line clog preventing system 100, a drain line disinfecting system 100, or a drain line cleaning system 100. Similarly, the drain line sanitation device 110 can for example alternatively be called a drain line clog preventing device 110, a drain line disinfecting device 110, or a drain line cleaning device 110.

Here has thus been described a multitude of embodiments of the air-conditioning drain line sanitation device 110, and systems and methods related thereto, which can be employed in numerous modes of usage.

The many features and advantages of the invention are apparent from the detailed specification, and thus, it is intended by the appended claims to cover all such features and advantages of the invention, which fall within the true spirit and scope of the invention.

For example, in related embodiments, the drain line sanitation device 110 may be configured for installation on a vertical drain line 194 or vertical pipe 194, for example such that the container connector 230 includes a 90 degree bend in order to maintain a vertical orientation of the container assembly 112.

Many such alternative configurations are readily apparent and should be considered fully included in this specification and the claims appended hereto. Accordingly, since numerous modifications and variations will readily occur to those skilled in the art, the invention is not limited to the exact construction and operation illustrated and described, and thus, all suitable modifications and equivalents may be resorted to, falling within the scope of the invention.

What is claimed is:

1. An air-conditioning drain line sanitation system, comprising:
a) an air-conditioning unit, comprising a drain emission connector, such that the drain emission connector is configured to emit a condensate fluid from the air-conditioning unit during operation of the air-conditioning unit;
b) a drain line, which is configured with a hollow interior to allow the condensate fluid to flow away from the air-conditioning unit via the drain line; and
c) an air-conditioning drain line sanitation device, which comprises a container body, which comprises a sanitation composition, wherein the container body is configured to be detachable;
wherein the air-conditioning drain line sanitation device is connected between an outer end of the drain emission connector and a first end of the drain line to create a fluid connection between the drain emission connector and the drain line; wherein the air-conditioning drain line sanitation device is configured to mix the condensate fluid emitted from the drain emission connector with the sanitation composition, such that the sanitation composition sanitizes the condensate fluid and the drain line, whereby a risk of clogging the drain line is reduced.

2. The air-conditioning drain line sanitation system of claim 1, wherein the air-conditioning drain line sanitation device further comprises a line fitting, comprising:
a) a connector pipe segment, comprising inner and outer ends, and a connector aperture in a bottom side of the connector pipe segment; and
b) a container connector, which is connected to the bottom side of the connector pipe segment, around the connector aperture;
wherein the container body is removably attached to the container connector, such that an interior of the container body is in fluid contact with the connector pipe segment via the connector aperture.

3. The air-conditioning drain line sanitation system of claim 2, wherein the container body further comprises: an upper opening and the interior that is accessible via the upper opening;
such that an upper end of the container body is configured to detachably connect to a lower end of the container connector to create a tight lock;
such that the condensate fluid flows via the upper opening into the interior, such that the condensate fluid mixes with the sanitation composition;
whereby a flow of condensate fluid past the connector aperture in the connector pipe segment causes the condensate fluid mixed with the sanitation composition to flow back into the connector pipe segment and subsequently into the drain line.

4. The air-conditioning drain line sanitation system of claim 3, wherein the upper end of the container body is configured with a line connector, which is configured to detachably connect with a lower end of the container connector.

5. The air-conditioning drain line sanitation system of claim 4, wherein the line connector is a snap-lock connector, comprising snap lock tabs.

6. The air-conditioning drain line sanitation system of claim 4, wherein the line connector is a threaded connector, comprising threading.

7. The air-conditioning drain line sanitation system of claim 3, further comprising a container assembly, which comprises:
the container body; and
a sealing plate, which is positioned on a top of the container body, such that the sealing plate comprises at least one sealing aperture, to allow the condensate fluid to flow via the at least one sealing aperture into the interior;
wherein the sealing plate is permanently connected to the container body.

8. The air-conditioning drain line sanitation system of claim 7, wherein the sealing plate is sonic welded to the container body.

9. The air-conditioning drain line sanitation system of claim 7, wherein the container body is configured with an inside ledge on an inner side of an upper rim of the container body, such that the sealing plate rests on the inside ledge, such that an upper surface of the sealing plate is flush with an upper surface of the upper rim of the container body.

10. The air-conditioning drain line sanitation system of claim 7, wherein the container assembly further comprises:
a sealing ring, which is positioned between the sealing plate and the container connector.

11. The air-conditioning drain line sanitation system of claim 7, wherein the at least one sealing aperture of the sealing plate comprises:
a central aperture configured with a cross-diagonal bar;
wherein the air-conditioning drain line sanitation device further comprises:
a dissolvable bag, which is positioned in the interior of the container body, wherein the dissolvable bag is configured to be dissolvable by the condensate fluid, wherein the dissolvable bag comprises the sanitation composition;
such that the cross-diagonal bar prevents removal of the dissolvable bag with the sanitation composition from the container body.

12. The air-conditioning drain line sanitation system of claim 7, wherein the container assembly further comprises:
a sealing ring, which is positioned between the sealing plate and the container connector;
wherein the sealing plate comprises:
a disc-shaped peripheral member, which comprises:
a central aperture, wherein the at least one sealing aperture comprises the central aperture;
wherein the sealing ring is disc-shaped, such that the sealing ring is positioned on a top of the disc-shaped peripheral member.

13. The air-conditioning drain line sanitation system of claim 12, wherein the disc-shaped peripheral member is further configured with:
a plurality of sealing apertures, such that the sealing apertures aid in detachment of the container body from the container connector, by reducing a suction effect between the sealing ring and the disc-shaped peripheral member.

14. The air-conditioning drain line sanitation system of claim 13, wherein the sealing apertures each have a diameter in a range of 0.5 to 10 mm.

15. The air-conditioning drain line sanitation system of claim 1, wherein the container body is made of a transparent material.

16. The air-conditioning drain line sanitation system of claim 3, wherein the line fitting and the container body are made of a transparent material.

17. The air-conditioning drain line sanitation system of claim 1, wherein the sanitation composition is water soluble and comprises a disinfectant agent.

18. The air-conditioning drain line sanitation system of claim 17, wherein the sanitation composition is a powder.

19. A drain line sanitation system, comprising:
a drain line sanitation device, which comprises a container body, which comprises a sanitation composition, wherein the container body is configured to be detachable;
wherein the drain line sanitation device is configured to connect between an outer end of a drain emission connector and a first end of a drain line to create a fluid connection between the drain emission connector and the drain line;
wherein the drain line sanitation device is configured to mix a condensate fluid emitted from the drain emission connector with the sanitation composition, such that the sanitation composition sanitizes the condensate fluid and the drain line, whereby a risk of clogging the drain line is reduced.

20. The drain line sanitation system of claim 19, wherein the drain line sanitation device further comprises a line fitting, comprising:
a) a connector pipe segment, comprising inner and outer ends, and a connector aperture in a bottom side of the connector pipe segment; and
b) a container connector, which is connected to the bottom side of the connector pipe segment, around the connector aperture;
wherein the container body is removably attached to the container connector, such that an interior of the container body is in fluid contact with the connector pipe segment via the connector aperture.

21. The drain line sanitation system of claim 20, wherein the container body further comprises: an upper opening and the interior that is accessible via the upper opening;
such that an upper end of the container body is configured to detachably connect to a lower end of the container connector to create a tight lock;
such that the condensate fluid flows via the upper opening into the interior, such that the condensate fluid mixes with the sanitation composition;
whereby a flow of condensate fluid past the connector aperture in the connector pipe segment causes the condensate fluid mixed with the sanitation composition to flow back into the connector pipe segment and subsequently into the drain line.

22. The drain line sanitation system of claim 21, further comprising a container assembly, which comprises:
the container body; and
a sealing plate, which is positioned on a top of the container body, such that the sealing plate comprises at least one sealing aperture, to allow the condensate fluid to flow via the at least one sealing aperture into the interior;
wherein the sealing plate is permanently connected to the container body.

23. The drain line sanitation system of claim 22, wherein the container body is configured with an inside ledge on an inner side of an upper rim of the container body, such that the sealing plate rests on the inside ledge, such that an upper surface of the sealing plate is flush with an upper surface of the upper rim of the container body.

24. The drain line sanitation system of claim 22, wherein the container assembly further comprises:
a sealing ring, which is positioned between the sealing plate and the container connector.

25. The drain line sanitation system of claim 22, wherein the at least one sealing aperture of the sealing plate comprises:
a central aperture configured with a cross-diagonal bar;
wherein the drain line sanitation device further comprises:
a dissolvable bag, which is positioned in the interior of the container body, wherein the dissolvable bag is configured to be dissolvable by the condensate fluid, wherein the dissolvable bag comprises the sanitation composition;
such that the cross-diagonal bar prevents removal of the dissolvable bag with the sanitation composition from the container body.

26. The drain line sanitation system of claim 24, wherein the sealing plate comprises:
a disc-shaped peripheral member, which comprises:
a central aperture, wherein the at least one sealing aperture comprises the central aperture;
wherein the sealing ring is disc-shaped, such that the sealing ring is positioned on a top of the disc-shaped peripheral member.

27. The drain line sanitation system of claim 26, wherein the disc-shaped peripheral member is further configured with:
a plurality of sealing apertures, such that the sealing apertures aid in detachment of the container body from the container connector, by reducing a suction effect between the sealing ring and the disc-shaped peripheral member.
